(19) United States
(12) Patent Application Publication
(10) Pub. No.: US 2025/0367989 A1
(43) Pub. Date: Dec. 4, 2025

(54) MULTI-TIRE AIR INFLATION/DEFLATION SYSTEM

(71) Applicant: Tyler Laursen, Sacramento, CA (US)

(72) Inventor: Tyler Laursen, Sacramento, CA (US)

(21) Appl. No.: 18/680,743

(22) Filed: May 31, 2024

(51) Int. Cl. B60C 29/06; B60C 23/00

(52) U.S. Cl. CPC B60C 29/064; B60C 23/00354

(57) ABSTRACT

A multi-tire inflation/deflation system. The multi-tire inflation/deflation system includes an air compressor, the air compressor configured to take in ambient air and discharge compressed air at a pressure higher than ambient pressure and a power input for the air compressor, where the power input is configured to provided electrical power to the air compressor. The multi-tire inflation/deflation system also includes a control, where the control allows the user to select a desired pressure and an output hose, where the compressed air is output from the air compressor. The multi-tire inflation/deflation system further includes a connector, where the connector allows the output to be connected to an external device and a slide valve, where the slide valve is configured to allow a user to turn off or on the air flow as desired.

### CROSS-REFERENCE TO RELATED APPLICATIONS

Not applicable.

### BACKGROUND OF THE INVENTION

There are a number of circumstances where it is necessary to deflate (and subsequently inflate) all of the tires of a vehicle. For example, before driving on sand, drivers of four-wheel vehicles deflate their vehicle's tires so that they make a wider and longer surface across the top of the sand, rather than digging holes and potentially bogging down. This allows the vehicle to continue moving forward relatively easily without wheel spin and gives a much softer ride over holes. Similarly, on rocky roads that are loose with sharp rocks, deflating tires can allow them to conform to rocks that might otherwise pierce the tire.

Conventional techniques for deflating tires usually involve the driver getting down on their knees to manually press the pin of the valve of each tire. This means that the driver needs to get down on their knees four times, which can be hard work, especially for older drivers. It can also be difficult to deflate all the vehicle's tires to the same pressure which, if not done correctly, can adversely affect the driving performance of the vehicle and increase wear.

A similar procedure needs to be repeated upon the vehicle returning to paved roads, with the driver having to go to each tire, fit the outlet of an air compressor to the tire's valve and inflate the tire. Again, this is a time consuming and relatively strenuous activity, and inconsistencies in the pressures to which each tire is inflated can easily occur at this time. As noted above, tires having different pressures can adversely affect the driving performance of the vehicle and increase wear, and even more so as the vehicle is likely to be driven faster and for longer in this condition.

Accordingly, there is a need in the art for a device that can simplify the procedure for deflating and inflating all a vehicle's tires. In particular, there is a need in the art for a device that allows a user to deflate all tires of a vehicle simultaneously and evenly while identifying the pressure for the user. Likewise, there is a need in the art for a device that can inflate all tires of a vehicle simultaneously and evenly while identifying the pressure for the user.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a multi-tire inflation/deflation system. The multi-tire inflation/deflation system includes an air compressor, the air compressor configured to take in ambient air and discharge compressed air at a pressure higher than ambient pressure and a power input for the air compressor, where the power input is configured to provided electrical power to the air compressor. The multi-tire inflation/deflation system also includes a control, where the control allows the user to select a desired pressure and an output hose, where the compressed air is output from the air compressor. The multi-tire inflation/deflation system further includes a connector, where the connector allows the output to be connected to an external device and a slide valve, where the slide valve is configured to allow a user to turn off or on the air flow as desired.

Another example embodiment includes a multi-tire inflation/deflation system. The multi-tire inflation/deflation system includes an air compressor, the air compressor configured to take in ambient air and discharge compressed air at a pressure higher than ambient pressure and a power input for the air compressor, where the power input is configured to provided electrical power to the air compressor. The multi-tire inflation/deflation system also includes a control, where the control allows the user to select a desired pressure and an output hose, where the compressed air is output from the air compressor. The multi-tire inflation/deflation system further includes a connector, where the connector allows the output to be connected to an external device and a slide valve, where the slide valve is configured to allow a user to turn off or on the air flow as desired. The multi-tire inflation/deflation system additionally includes a hose kit. The hose kit includes a manifold, where the manifold is configured to connect to the connector at a single input and includes multiple outputs and a gauge attached to the manifold. The hose kit also includes a first hose connected to a first output on the manifold and a first air chuck attached to the first hose. The hose kit further includes a second hose connected to a second output on the manifold and a second air chuck attached to the second hose.

Another example embodiment includes a multi-tire inflation/deflation system. The multi-tire inflation/deflation system includes an air compressor, the air compressor configured to take in ambient air and discharge compressed air at a pressure higher than ambient pressure and a power input for the air compressor, where the power input is configured to provided electrical power to the air compressor. The multi-tire inflation/deflation system also includes a control, where the control allows the user to select a desired pressure and an output hose, where the compressed air is output from the air compressor. The multi-tire inflation/deflation system further includes a connector, where the connector allows the output to be connected to an external device and a slide valve, where the slide valve is configured to allow a user to turn off or on the air flow as desired. The multi-tire inflation/deflation system additionally includes a hose kit. The hose kit includes a manifold, where the manifold is configured to connect to the connector at a single input and includes multiple outputs and a gauge attached to the manifold. The hose kit also includes a first manifold output hose connected to a first output on the manifold and a first fitting connected to the first manifold output hose, where the first fitting includes an input connected to the first manifold output hose. The hose kit further includes a first tire hose, where the first tire hose is connected to a first output of the first fitting and a first air chuck attached to the first tire hose. The hose kit additionally includes a second tire hose, where the second tire hose is connected to a second output of the first fitting and a second air chuck attached to the second tire hose. The hose kit also includes a second manifold output hose connected to a second output on the manifold and a second fitting connected to the second manifold output hose, where the second fitting includes an input connected to the first output hose. The hose kit further includes a third tire hose, where the third tire hose is connected to a first output of the second fitting and a third air chuck attached to the third tire hose. The hose kit additionally includes a fourth tire hose, where the fourth tire hose is connected to a second output of the first fitting and a fourth air chuck attached to the fourth tire hose.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a multi-tire inflation/deflation system; and

FIG. 2 illustrates an example of a multi-tire inflation/deflation system attached to a vehicle.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

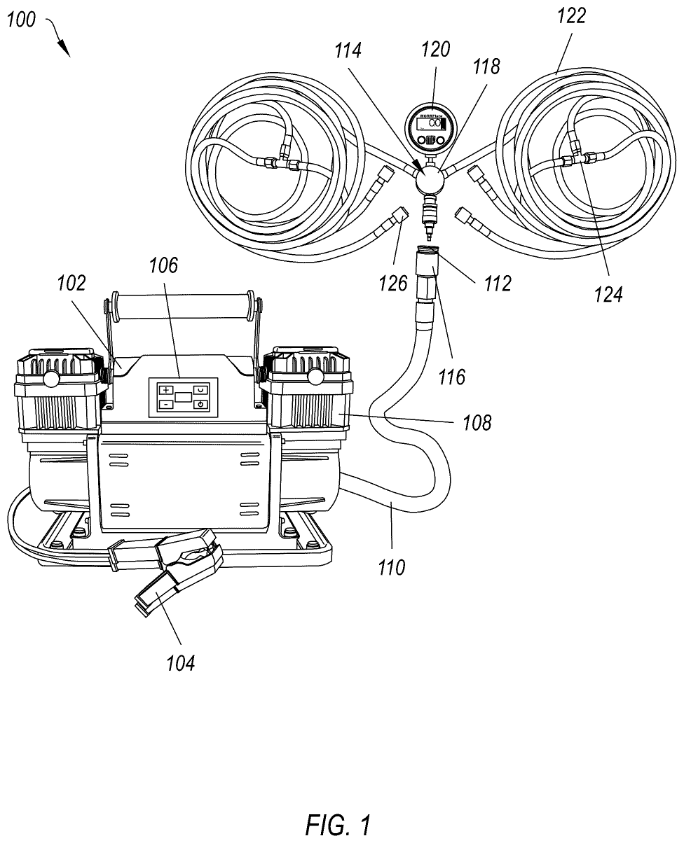

FIG. 1 illustrates an example of a multi-tire inflation/deflation system 100. The multi-tire inflation/deflation system 100 is configured to ensure that all tires of a vehicle have the same air pressure. The multi-tire inflation/deflation system 100 equalizes the pressure of all tires and can remove air or add air to move all tires to the desired pressure. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 shows that the multi-tire inflation/deflation system 100 can include an air compressor 102. The air compressor 102 is a machine that takes ambient air from the surroundings and discharges it at a higher pressure. It is an application of a gas compressor and a pneumatic device that converts mechanical power (from an electric motor, diesel or gasoline engine, etc.) into potential energy stored in compressed air. I.e., the air compressor 102 can move air from an area of lower pressure to an area of higher pressure.

The air compressor 102 does not include a reservoir like some air compressors. This is critical because an air reservoir makes the air compressor less portable. For many compressors the reservoir is the largest part of an air compressor, which makes the air compressor less portable. I.e., for users who are trying to offroad and adjust tire pressure to conditions, the reservoir makes the compressor too large to store and transport. In particular, if a reservoir is small enough to be easily portable, then it doesn't make an appreciable difference in inflation time, but if it is large enough to have an influence on inflation time (at least 7-10 gallons), then it isn't portable.

Instead, the air compressor 102 moves air dynamically. That is, the air compressor 102 moves air directly to the area where it is needed. That means that the air compressor 102 can move air into or out of the tires without the use of an air reservoir. Further, the air compressor 102 is capable of moving enough air at enough pressure that it can inflate or deflate multiple tires simultaneously. One of skill in the art will appreciate that the air compressor 102 is the only component that actively moves air

FIG. 1 also shows that the air compressor 102 can include a power input 104. The power input 104 allows the air compressor to be connected to an external power source, such as a car battery via battery clips. Battery clips are spring loaded clips that allow a user to connect the power input 104 to the terminals of the vehicle battery.

FIG. 1 further shows that the air compressor 102 can include a control 106. The control 106 allows the user to select a desired operation and a pressure. If the selected pressure is below the current pressure of the attached tires, then the air compressor 102 will remove air from the tires; if the air pressure is above the current pressure of the attached tires, then the air compressor 102 will add air to the tires.

FIG. 1 additionally shows that the air compressor 102 can include a heat sink 108. The heat sink 108 is made of aluminum. Many air compressors use the thermoplastic polymer acrylonitrile butadiene styrene (ABS). However, aluminum is a superior thermal conductor which allows heat from the air compression operation to be dissipated quickly and effectively via the heat sink 108.

FIG. 1 further shows that the multi-tire inflation/deflation system 100 can include an output hose 110. The output hose 110 is where the air exits the compressor. I.e., the output hose 110 is where the higher pressure air is output from the air compressor 102. The output hose 110 can be connected, directly or indirectly, to the tires of the vehicle. The output hose 110 is made of stainless steel, allowing it to withstand greater pressures in the output air.

FIG. 1 additionally shows that the multi-tire inflation/deflation system 100 can include a connector 112. The connector 112 allows the output hose 110 to be connected to an external device, such as a tire or hose kit 114. I.e., the connector 112 creates a connection that allows pressurized air to flow out of the output hose 110 to a location desired by the user.

FIG. 1 moreover shows that the multi-tire inflation/deflation system 100 can include a slide valve 116. The slide valve allows the user to turn off or on the air flow to the tires. I.e., the slide valve 116 can be pushed to a first position where air flows or to a second position where no air is allowed to flow. The slide valve 116 is easier for users to activate than other valves such as ball valves. In addition, the slide valve 116 is slower to break down than other valve types. In order to deflate the system 100 (including any attached tires) the user can open the slide valve 116 without the air compressor 102 operating and air will flow out of the system. When the system reaches the desired pressure the user can close the slide valve 116 preventing further deflation.

FIG. 1 additionally shows that the multi-tire inflation/deflation system 100 can include a hose kit 114. The hose kit 114 transports the air from the manifold 118 to the tires of the vehicle. Air pressure with the hose kit 114 equalizes quickly, so air pressure within the tires can equalize quickly. I.e., air pressure within the hose kit 114 is equal at all points which extends into connected tires and ensures that tire pressure is equalized within all tires.

FIG. 1 also shows that the hose kit 114 can include a manifold 118. The manifold 118 receives compressed air from the output hose 110 via the connector 112 and splits the air flow into two or more outputs. I.e., the manifold 118 connects a single input with multiple outputs. One of skill in the art will appreciate that the terms “input” and “output” are not necessarily defined by air flow. For example, if the air compressor is being used to deflate tires, then airflow is from multiple outputs in the manifold 118 to a single input of the manifold 118. During an inflation operation, the air flow is from the single input of the manifold 118 to the multiple outputs of the manifold 118.

FIG. 1 further shows that the hose kit 114 can include a gauge 120. For example, the gauge 120 can be attached to the hose kit 114 at the manifold 118. The gauge 120 allows the user to determine the current pressure in the multi-tire inflation/deflation system 100 and by extension any connected tires. This allows the user to determine the current state of all tires simultaneously. The gauge 120 can be an analog or digital gauge. The gauge 120 is not as accurate when the air compressor 102 is actively moving air, because air currents cause noise in the gauge. However, it can be used to approximate the pressure and will be accurate when the air compressor 102 is not actively moving air.

FIG. 1 moreover shows that the hose kit 114 can include one or more air hoses 122. The air hoses 122 can include multiple sections, such as a manifold output hose and tire hoses (which may be the same material but are differentiated only in the part of the hose kit 114 or external device to which the hose is attached). The air hoses 122 consist of 3 layer rubberized polyvinyl chloride (“PVC”) material. Rubberized PVC is freeze resistant. In addition, rubberized PVC does not hold memory so it lays flat for each use. Further, rubberized PVC is UV resistant, which prevents breakdown when left in sunlight. Experimentation has shown that the optimal inner diameter of the air hoses 122 is approximately 0.25 inches, which is critical to allow enough air flow but prevents the air hoses 122 from becoming overly bulky, preventing use by a user. As used in the specification and the claims, the term approximately shall mean that the value is within 10% of the stated value, unless otherwise specified.

FIG. 1 also shows that the hose kit 114 can include fittings 124. The fitting 124 allow one input air hose 122 to be connected to multiple output air hoses 122. This allows a user to connect as many desired tires. For example, if the user needs to connect to a vehicle with six tires, then one air hose 122 can be split to two air hoses 122, which can be split via another fitting 124 into three air hoses 122, allowing all three tires on a single side of a vehicle to be connected to the multi-tire inflation/deflation system 100. One of skill in the art will appreciate that the fittings 124 reduces the amount of air flow in the output hoses (since the output hoses have a bigger combined cross-sectional area than the input cross-sectional area), therefore, the air compressor 102 needs to be capable of creating enough flow to inflate all connected tires via all connected air hoses 122.

FIG. 1 further shows that the hose kit 114 can include a locking air chuck 126. The locking air chuck 126 attaches to the stem valve of a tire and then locks into place. The locking air chuck 126 is placed as far as possible on the stem valve of a tire with collar 128 pulled all the way back. The user then slides the collar 128 forward while holding pressure on the valve stem. Unless placed on a stem valve, the locking air chuck 126 defaults to a closed position to prevent air leakage. Thus, if three locking air chucks 126 are placed on tires and a fourth locking air chuck 126 is left free, air will only flow through the three air hoses 122 which are connected to tires via a locking air chuck 126.

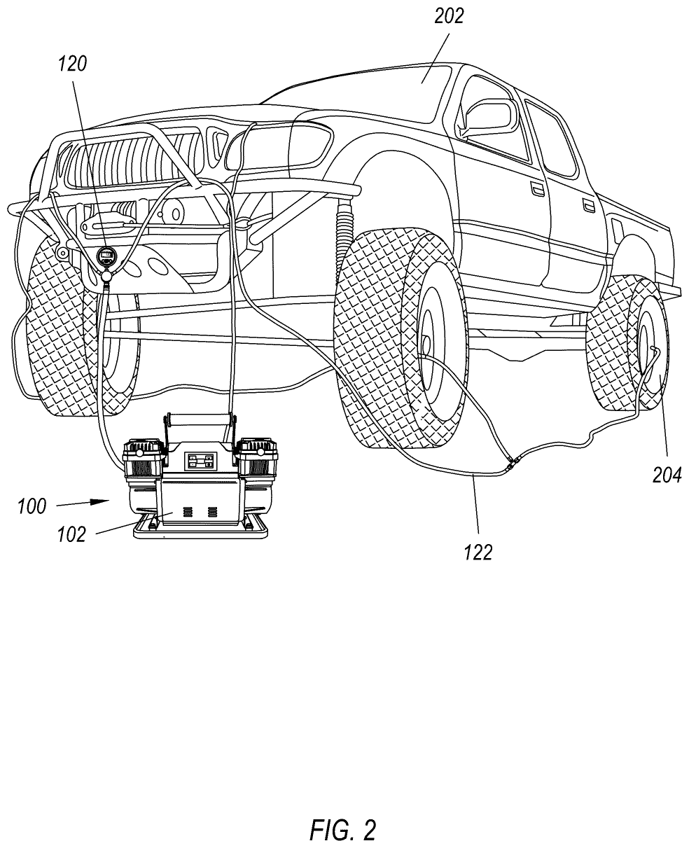

FIG. 2 illustrates an example of a multi-tire inflation/deflation system 100 attached to a vehicle 202. The vehicle 202 has four tires 204, but can include any number of tires and the multi-tire inflation/deflation system 100 can be used to inflate a single tire if needed. The tires 204 of the vehicle become equalized with the same pressure. The multi-tire inflation/deflation system 100 is capable of increasing or decreasing the tire pressure.

When first placed on the tires 204 the multi-tire inflation/deflation system 100 equalizes all pressures within the tires 204, since the air hoses 122 have an open connection to all tires 204 via the locking air chucks 126. I.e., all tires and the air hoses 122 become a single system with equal pressure throughout. The pressure can be determined by the user via gauge 120. The user can then set the desired pressure on the control 106 and the air compressor 102 will either add air or remove air depending on what is needed to achieve the desired final pressure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hose kit, the hose kit comprising:
an input hose, wherein the input hose is configured to receive compressed air;
a manifold, wherein the manifold is configured to connect to the input hose at a single input and includes multiple outputs;
a gauge attached to the manifold;
a first hose connected to a first output on the manifold;
a first connector attached to the first hose, wherein the first connector is configured to connect the first hose to a first external device;
a second hose connected to a second output on the manifold; and
a second connector attached to the second hose, wherein the second connector is configured to connect the second hose to a second external device.

2. The system of claim 1, wherein the first external device includes a tire.

3. The system of claim 1, wherein the first external device includes an air chuck.

4. The system of claim 1 further comprising:
a first fitting connected to the first connector, wherein the first fitting includes an input connected to the first connector;
a third hose, wherein the third hose is connected to a first output of the first fitting;
a third connector attached to the third hose;
a fourth hose, wherein the fourth hose is connected to a second output of the first fitting; and
a fourth connector attached to the fourth hose.

5. The system of claim 4 further comprising:
a second fitting connected to the second connector, wherein the second fitting includes an input connected to the second connector;
a fifth hose, wherein the fifth hose is connected to a first output of the second fitting;
a fifth connector attached to the fifth hose;
a sixth hose, wherein the sixth hose is connected to a second output of the second fitting; and
a sixth connector attached to the sixth hose.

6. The system of claim 5 wherein
the third connector includes a first air chuck;
the fourth connector includes a second air chuck;
the fifth connector includes a third air chuck; and
the sixth connector includes a fourth air chuck.

7. The system of claim 1, wherein the gauge includes a digital gauge.

8. The system of claim 1, wherein the user may perform a deflation operation by opening the slide valve without the air compressor operational.

9. The system of claim 1, wherein the input hose includes a stainless steel hose.

10. A multi-tire inflation/deflation system, the multi-tire inflation/deflation system comprising:
an air compressor, the air compressor configured to take in ambient air and discharge compressed air at a pressure higher than ambient pressure;
a power input for the air compressor, wherein the power input is configured to provided electrical power to the air compressor;
a control, wherein the control allows the user to select a desired pressure;
an output hose, wherein the compressed air is output from the air compressor;
a connector, wherein the connector allows the output to be connected to an external device;
a slide valve, wherein the slide valve is configured to allow a user to turn off or on the air flow as desired; and
a hose kit, wherein the hose kit includes:
a manifold, wherein the manifold is configured to connect to the connector at a single input and includes multiple outputs;
a gauge attached to the manifold;
a first hose connected to a first output on the manifold;
a first air chuck attached to the first hose;
a second hose connected to a second output on the manifold; and
a second air chuck attached to the second hose.

11. The system of claim 10, wherein the air compressor includes a heat sink.

12. The system of claim 11, wherein the heat sink includes aluminum.

13. The system of claim 10 further comprising a slide valve, wherein the slide valve allows the user to turn on or off the air flow through the output hose.

14. The system of claim 10, wherein the first air chuck and the second air chuck include locking air chucks.

15. The system of claim 10, wherein the power input is configured to attach to a vehicle battery.

16. The system of claim 15, wherein the power input includes a pair of battery clips.

17. A multi-tire inflation/deflation system, the multi-tire inflation/deflation system comprising:
an air compressor, the air compressor configured to take in ambient air and discharge compressed air at a pressure higher than ambient pressure;
a power input for the air compressor, wherein the power input is configured to provided electrical power to the air compressor;
a control, wherein the control allows the user to select a desired pressure;
an output hose, wherein the compressed air is output from the air compressor;
a connector, wherein the connector allows the output to be connected to an external device;
a slide valve, wherein the slide valve is configured to allow a user to turn off or on the air flow as desired; and
a hose kit, wherein the hose kit includes:
a manifold, wherein the manifold is configured to connect to the connector at a single input and includes multiple outputs;
a gauge attached to the manifold;
a first manifold output hose connected to a first output on the manifold;
a first fitting connected to the first manifold output hose, wherein the first fitting includes an input connected to the first manifold output hose;
a first tire hose, wherein the first tire hose is connected to a first output of the first fitting;
a first air chuck attached to the first tire hose;
a second tire hose, wherein the second tire hose is connected to a second output of the first fitting;
a second air chuck attached to the second tire hose;
a second manifold output hose connected to a second output on the manifold;
a second fitting connected to the second manifold output hose, wherein the second fitting includes an input connected to the first output hose;
a third tire hose, wherein the third tire hose is connected to a first output of the second fitting;
a third air chuck attached to the third tire hose;
a fourth tire hose, wherein the fourth tire hose is connected to a second output of the first fitting; and
a fourth air chuck attached to the fourth tire hose.

18. The system of claim 17, wherein the air compressor initiates an inflation operation when the pressure set on the control is above the current pressure within the hose kit.

19. The system of claim 17, wherein the air hoses each have an inner diameter of approximately 0.25 inches.

20. The system of claim 17, wherein the air hoses each include rubberized polyvinyl chloride.
